(19) United States
(12) Patent Application Publication
(10) Pub. No.: US 2025/0130754 A1
(43) Pub. Date: Apr. 24, 2025

(54) REMOTE ACCESS MOBILE COMMUNICATIONS SYSTEM AND METHOD

(71) Applicant: L2NL, LLC

(72) Inventor: Karl Deiotte, GAINESVILLE, VA (US)

(73) Assignee: L2NL, LLC, (omitted)

(21) Appl. No.: 18/924,227

(22) Filed: Oct. 23, 2024

Related U.S. Application Data
(60) Provisional application No. 63/592,240, filed on Oct. 23, 2023.

(51) Int. Cl. G06F 3/14

(52) U.S. Cl. CPC G06F 3/1454

(57) ABSTRACT

A mobile communications system comprises a host device and a target device. A connection is established between the host device and the target device. Remote desktop protocol permits mirroring of audio and video originated from the target device on the host device, and prohibits data transmission of data from the target device to the host device.

### BACKGROUND OF THE INVENTION

When operating in remote, contested, or unfriendly environments, it is often advisable to use a “burner phone” to avoid data loss, compromise, or confiscation of one's business or personal information and data. The “burner phone” approach is a workable solution for maintaining continuity of communications (voice, video, and text-based) and some level of access to necessary data (email, analytical products, etc.) using connections to cloud or otherwise publicly hosted services.

However, this approach requires pre-distribution of new contact information and logging into enterprise services from potentially untrusted or unfriendly network environments (Host Domain). Additionally, there may be applications and data on a user's business or personal phone that are critical for daily operations regardless of physical location and/or operating environment (authenticator applications, software security tokens, hardware roots of trust, etc.).

### SUMMARY OF THE INVENTION

The present invention proposes a solution to this problem by enabling secure remote access to a Target Device while removing methods and avenues for data flows from Host Device to Target Device. This allows use of a Target Device from locations otherwise restricted, contested, unfriendly, or untrusted.

The invention provides ephemeral access and data transfer prevention at the architectural level. The invention provides ephemeral access to remote phones, leaving no data on the Host Device. Only streaming audio and video data leaves the Target Device. Architectural Data Transfer prevention of data transmitted from the Host Device to the Target Device includes video, audio, and touch-initiated information. Data transmitted from the Target Device to the Host Device is limited to streaming audio and video. This invention mitigates data transfer through its architecture, unlike existing solutions that rely on policy enforcement.

### BRIEF DRAWING DESCRIPTION

FIG. 1 is a schematic diagram of the invention.

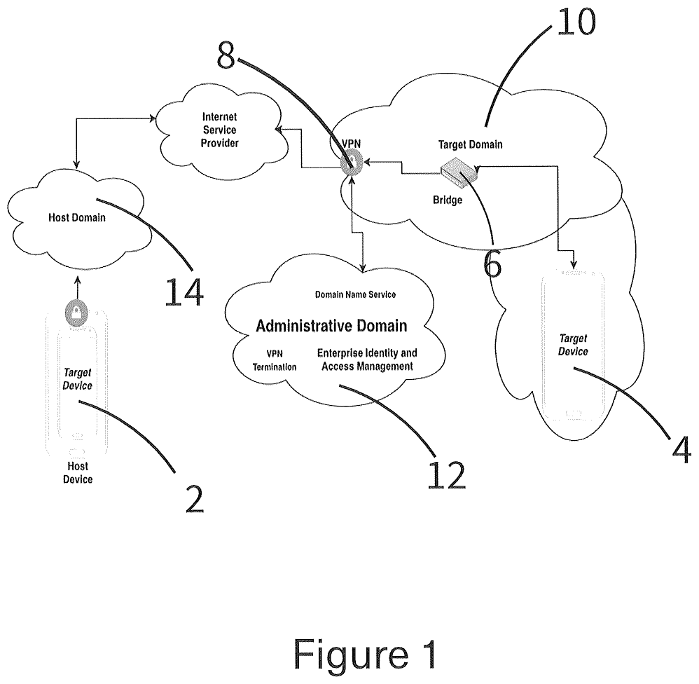

FIG. 2 shows an interaction of elements of an embodiment of the invention.

FIG. 3 shows one embodiment of the invention representing deployed soldiers, foreign embassy workers, or journalists.

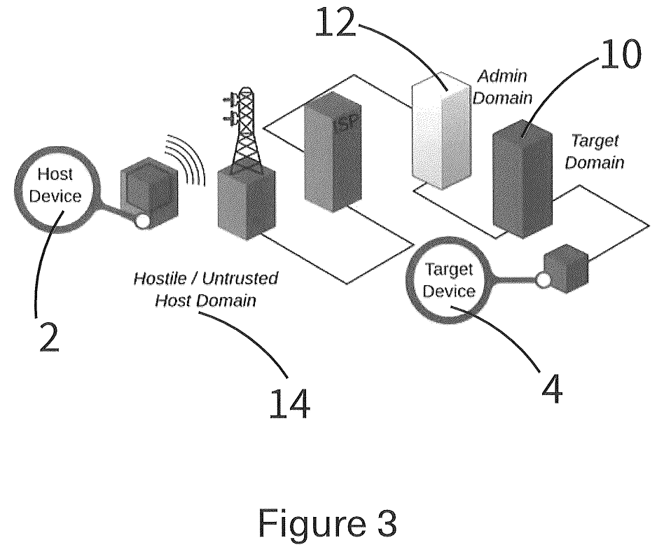

### EMBODIMENTS OF THE INVENTION

The present invention uses hardware, software, and a process to deliver access to a virtualized mobile phone and the associated information and communications architectures. Methods and devices for accessing a user's primary mobile telephone or similar device via the public internet from a “burner phone,” otherwise untrusted mobile device, or temporary mobile device, are disclosed. Enabling secure access to trusted, secured devices via untrusted or less secure communications devices after robust identity proofing and access controls provides mobile device users with flexibility to use any host mobile device to access a target device in a trusted computing environment.

Definitions as used herein are provided:

Domain—Information environment (for example, corporate network, Government network, mobile network).

Host Device—Mobile device 2 (for example, Android or iOS) using the software Application described herein, which may be a temporary or secondary mobile phone, or “burner” phone, or similar mobile device.

Host Domain—The Domain/information environment to which the Host device is connected. The Host Domain 14 may be a mobile network, ethernet network, physical location, or security classification domain.

Target Device—A mobile device 2 and/or operating system that is connected to the Target Domain 10, which may be an Android mobile device in an example embodiment.

Target Domain—The Domain/information environment to which the Host device is connected. The Target Domain 10 may be a mobile network, ethernet network, physical location, or security classification domain.

Bridge—Hardware (server) and Linux-based operating system comprising the remote desktop protocol (RDP) server and terminating the RDP connection from the Host Device application. The Bridge 6 is connected via USB to the Target Device 4. Another embodiment of the solution is to run a containerized version of the Android operating system on the Bridge, removing the need for a physical Target Device altogether.

Administrative Domain—The Domain/information environment from which enterprise identity and access (IAM) and virtual private network (VPN) capabilities are served. These capabilities are most often resources of the Target Domain 4, but are externally facing and support resources requesting access to the Target Domain. The Administrative Domain 12 (or Admin Domain) and Target Domain 10 can be the same domain, based on the architecture of the information environments. The Administrative Domain may be, for example, a network de-militarized zone (DMZ) that provides identity and access management services for the Target Domain before granting access to the Target Domain.

Application—A custom mobile device application that automates communication with the identity and authentication providers, establishes a VPN connection 8 with the Target Domain 10 in a preferred embodiment, and establishes an RDP connection from the Host RDP client to the Bridge RDP server.

VPN—A Virtual Private Network may be used to securely connect computing devices to the same logical network infrastructure. As embodied in the present invention, a VPN 8 enables a connection from Host Domain 14 to Target Domain 10.

ICAM—Identity, Credentialing, and Access Management. Enterprise services delivering identity proofing, credential management, and access control for the Target Domain 10.

RDP—in an embodiment, an open source remote desktop protocol (RDP) client, or similar protocol, which is used to enable virtual sessions from the Host Device 2 to the Bridge 6.

SCRCPY—(or Screen Copy) allows display and control of mobile device such as an Android device from a computer and in an embodiment of the invention is used tool used to mirror (reflect) a user interface between the mobile device and an operating system on the Bridge 6, which may be a Linux-based operating system.

BYOD—Bring your own device. BYOD is a policy that allows users to access enterprise or corporate resources through personally owned devices and not within the security boundary/perimeter of the enterprise. This device may be, for example, a personal mobile device or a “burner phone.”

In a preferred embodiment, there are five primary components of the system: Host Device 2, Target Device 4, Bridge 6, VPN 8, and the Application.

The Target Device 2 may be a mobile device running an Android operating system connected via microservice, wired ethernet, Wi-Fi, or LTE network to the Target Domain 10. The Target Device is enrolled in desired communications, collaboration, and services available within the Target Domain. The Target Device may be a corporate or government issued cellular telephone or could be a BYOD phone with access to the target environment.

In one embodiment, when a User is present in a remote location, the Target Device 2 that is the User's primary mobile device is intentionally positioned in another more secure or familiar location, such as at the user's resident or business. Traveling or remote users can access the Target Device via the Application, for example, on a temporary mobile device such as a “burner phone” so that sensitive data or confidential data like software tokens, authenticator applications, graphics, and videos never leave the Target Domain 10.

This embodiment may be used to provide communications services to military personnel, embassy workers, operatives and journalists when traveling to hostile environments. The invention allows Users to place their personal or employer-issued mobile device (Target Device 4) in a secure environment, while providing access to Target Device services and capabilities, including authentication applications, files, contacts, geolocation, and communication applications

In an embodiment, a user launches the Application. The invention executes the following process:

VPN Connection to Administrative Domain: The Application establishes a private connection (e.g., VPN) to the Administrative Domain 12. The Administrative Domain initiates an ID challenge using the enterprise ICAM security protocol. If the challenge is valid, a VPN connection is established between the Host Device 2 and the Bridge 6.

RDP Connection to Bridge: The Application initiates an RDP connection with the Bridge (e.g., using RDP). The Bridge 6 is a computer server running a virtual machine or a containerized Linux-based operating system, connected to the Target Device via USB 2.0 or better. The Bridge performs an authentication challenge using the enterprise ICAM solution. If the response is valid, the Application establishes an RDP session between the Host Device 2 and the Target Device 4.

Device Mirroring: The Application initiates SCRCPY on the Bridge 6. SCRCPY mirrors the Target Device's user interface over a communications link (e.g., USB). The SCRCPY output is sent to the Host Device 4 via RDP through the established VPN tunnel.

In another embodiment, the Target Device 4 is a cellular telephone that is connected to a Target Domain 10 and enables control of that device on one domain from a device on another domain. This application may be useful, for example, when controlling smart home devices on isolated networks.

In an example, the Host Device 2 is the user's temporary secondary mobile device or BYOD device. The device may be a privately owned or government or enterprise issued cellular telephone or similar device. The Host Device must have the Application installed. When the user launches the Application, multiple events occur as described.

First, the Application initiates a private connection, such as via a VPN, to the Administrative Domain 12. The Administrative Domain initiates an ID challenge using the enterprise ICAM security protocol. If the challenge is valid, a VPN connection is established between the Host Device 2 and the Bridge 6.

Next, the Application initiates an RDP connection with the Bridge 6 such as by RDP. In a preferred embodiment, the Bridge is a computer server running a virtual machine or a containerized Linux-based operating system that is connected to the Target Device via communications protocol, such as USB 2.0 or better. The Bridge performs an authentication challenge using the enterprise ICAM solution. If the response is valid, the Application establishes an RDP session between the Host Device 2 and the Target Device 4.

Finally, the Application initiates an instance of SCRCPY on the Bridge. SCRCPY mirrors the user interface of the Target Device over a communications link such as the USB. The SCRCPY output is then sent back to the Host Device using RDP through the established VPN 8 tunnel.

The invention provides ephemeral access to remote phones that leave no data or information on the Host Device 2. The only data that leaves the Target Device 4 is streaming audio and video data. All file transfer, clipboard sharing, etc. is disallowed by default within the RDP protocol and can be further restricted using an enterprise Mobile Device Management (MDM) solution to prevent screen shots on the Host Device. Data transmitted from Host Device to Target Device includes video, audio, and touch initiated information. Data transmitted from the Target Device to the Host Device is limited to streaming audio and video. This is an improvement over existing solutions that must mitigate data transfer through policy, while the Application avoids it through architecture.

At a system level, the invention prevents data transfer via its architecture by only opening communications channels for audio and video data that are streamed to the Host Device 2. Access to the Target Device 4 is controlled through strong enterprise ICAM, Linux system permissions, and by the ephemeral nature of streaming video.

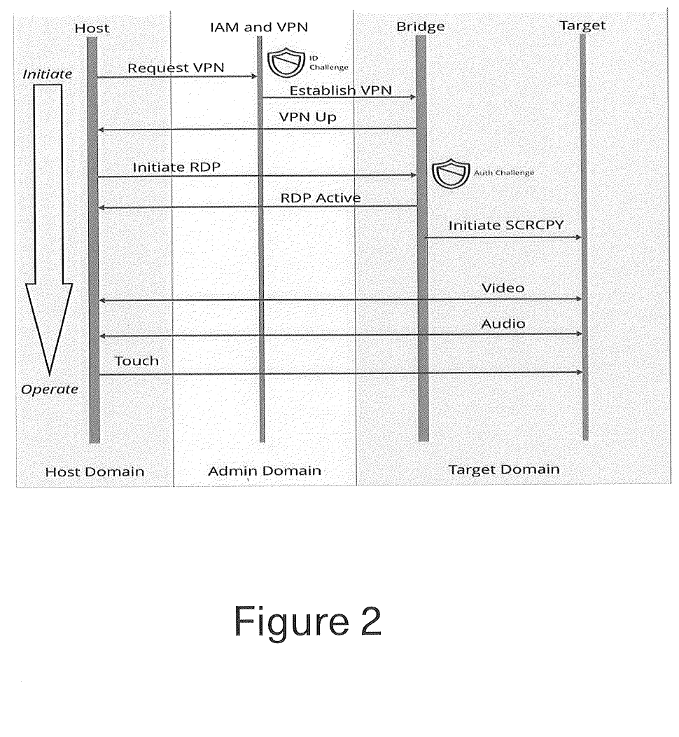

In an example of use, the user launches the Application. FIG. 2. When prompted for authentication, the user signs into the Target Domain 10 using single sign on (SSO) or other identification and access control provider. After successfully authenticating to the Target Domain, the Application will establish a VPN connection 8 from the Host Device 2 to the Target Domain. Once the VPN connection is established, the Application establishes an RDP session between the Host Device and the Bridge 6. Next, the Bridge launches SCRCPY and mirrors the Target Device user interface to the Bridge. The user now has full access and control of the Target Device via the Host Device.

The invention leverages tools to lower down the hardware and software stack itself. SCRCPY is a way of “virtualizing” the interface between the Bridge and the Target Device.

Investments already made in the lower tiers of the information environments are used, such as VPN services, ICAM, and load balancing, as well as the existing security authorization of the environment. The invention allows real-time enterprise control of access to the Target Domain and does not permit data exchange between the Target Domain and Host Domain 14.

What is claimed is:

1. A mobile communications system, comprising:
a host device,
a target device,
a software application controlled from the host device,
wherein the software application establishes a connection between the host device and the target device, and remote desktop protocol initiates mirroring of audio and video of the target device on the host device, and prohibits other data transmission from the target device to the host device.

2. The mobile communications system of claim 1, further comprising a bridge, wherein remote desktop protocol of the bridge permits mirroring of audio and video of the target device on the host device, and prohibits non-video and non-audio data transmission from the target device to the host device.

3. The mobile communications system of claim 1, further comprising a virtual private network connects a host domain of the host device to a target domain of the target device.

4. The mobile communications system of claim 1, wherein the software application initiates screen copy on the bridge, and wherein screen copy mirrors the target device's user interface and the mirrored user interface is provided to the host device.

5. obile communications system of claim 1, wherein the software application initiates screen copy on the bridge, and wherein screen copy mirrors the target device's user interface and the mirrored user interface is provided to the host device via remote desktop protocol and a virtual private network.

6. The mobile communications system of claim 1, the software application establishes a virtual private network connection with the target device, and establishes a remote desktop connection from the host device to the bridge.

7. The mobile communications system of claim 1, further comprising a mobile device management application that prohibits saving screen shots of mirrored video on the host device.

8. The mobile communications system of claim 1, wherein target device is accessed and controlled by the host device.

9. The mobile communications system of claim 1, the application establishes the remote desktop protocol session between the host device and a bridge, and the bridge launches screen copy and mirrors the target device user interface to the bridge.

10. The mobile communications system of claim 1, wherein access and data transfer from the target device to the host device is controlled by enterprise identity, credentialing, and access management protocol.

11. The mobile communications system of claim 1, wherein limiting transfer from the target device to the host device to audio and video images is controlled by enterprise identity, credentialing, and access management protocol.

12. A mobile communications system, comprising:
a host device,
a target device,
a bridge,
a communications link,
a software application controlled from the host device,
wherein the software application initiates a virtual private connection to an administrative domain that initiates an identification challenge using identity, credentialing, and access management protocol to establish a virtual private network between the host device and the bridge, and
wherein the software application initiates a remote desktop connection with the bridge, and a remote desktop protocol session is established between the host device and the target device, and
wherein the software application initiates screen copy on the bridge, and screen copy and mirrors the user interface of the target device over the communications link and output from screen copy output is communicated to the host device, and
wherein only communications channels for audio and video data are streamed to the host device.

13. The mobile communications system of claim 12, wherein access and data transfer from the target device to the host device is controlled by enterprise identity, credentialing, and access management protocol.

14. The mobile communications system of claim 1, wherein limiting transfer from the target device to the host device to audio and video images is controlled by enterprise identity, credentialing, and access management protocol.
